(19) United States
(12) Patent Application Publication
(10) Pub. No.: US 2011/0205742 A1
(43) Pub. Date: Aug. 25, 2011

(54) MODULAR LED LAMPS WITH INTEGRATED TRANSFORMER

(76) Inventor: Mark Timmy Lee, Yorba Linda, CA (US)

(21) Appl. No.: 13/035,812

(22) Filed: Feb. 25, 2011

Related U.S. Application Data
(60) Provisional application No. 61/307,999, filed on Feb. 25, 2010.

(51) Int. Cl. F21V 29/00; F21V 5/04

(52) U.S. Cl. 362/294; 362/311.02

(57) ABSTRACT

A lamp having a body with a threaded a outer surface, a light emitting diode compartment and a circuit compartment; a light emitting diode is mounted in the light emitting diode compartment; a driver board assembly is mounted in the circuit compartment; and a lens is removably mounted to the housing with a removable lens cap.

### CROSS REFERENCE TO RELATED APPLICATION

The present application claims priority of U.S Provisional Patent Application No. 61/307,999 filed on Feb. 25, 2010, entitled “Modular LED Lamps with Integrated Transformer”, the entire contents of which are hereby incorporated herein by reference.

### BACKGROUND

The present invention relates to lamps utilizing light emitting diodes (LED's), and more specifically to modular LED lamps with interchangeable and configurable components.

Until recently most lighting systems relied upon incandescent bulbs to provide the light. Incandescent bulbs are relatively inefficient which results in large amounts of entrapped heat energy, relatively short bulb life, and relatively high energy consumption. Additionally, incandescent bulbs are fragile and susceptible to breaking due to shock. These limitations of incandescent bulbs have led to limited interchangeability of fixtures.

Recently, due to improvements in LED technology, LED light sources have become available that can substitute for incandescent bulbs. However, the LED light source must be coupled to a transformer. The transformer is vulnerable to shock, heat and moisture. The limitations of the transformer have led to limited interchangeability of fixtures for LED lamps. Accordingly, there is a need for improved LED lamps to remedy the shortcomings of the prior art.

### SUMMARY OF THE INVENTION

Accordingly, the present invention according to an embodiment is direct to a lamp comprising a body having a threaded outer surface, a light emitting diode compartment; and a circuit compartment. A light emitting diode is mounted in the light emitting diode compartment; a driver board assembly is mounted in the circuit compartment; and a lens is removably mounted to the housing with a removable lens cap. Optionally, the transformer is removeably mounted in the transformer compartment. Additionally, the light emitting diode compartment and the transformer compartment may be separated by a backplate having a thickness of at least about 8 mm.

Additionally, the circuit compartment may have an inner wall with a groove; the driver board assembly being held inside of the circuit compartment with an adhesive, such as an expoxy, filling the groove. Additionally, the inner wall of the circuit compartment may intersect the backplate at an angled corner. Optionally, the light emitting diode compartment may comprise a wall having a thickness of at least about 3 mm. Additionally, the wall of the light emitting diode compartment may comprise a rim; and an o-ring sits on the ledge and is held in place by at least one of the removable lens cap and the lens. The removable lens cap may be configured to mount flush with the lens and the body.

In an additional embodiment of the invention, the lamp also has a wire assembly coupled to the driver board assembly; the wire assembly being fastened to the body by a wire protector. Optionally, the lamp further comprises a heat sink removably coupled to the body, the heat sink further comprising a first half removably coupled to a second half by a plurality of fasteners. Optionally, the lamp further comprises a plurality of lenses having different optical qualities removably coupleable to the body.

In an additional embodiment, the present invention is directed to a lamp comprising a body having a threaded outer surface; a light emitting diode compartment and a circuit compartment separated by a backplate, the backplate having a thickness of at least about 8 mm. A light emitting diode is mounted in the light emitting diode compartment; a transformer assembly is removeably mounted in the circuit compartment; and a lens is removeably mounted to the housing with a removable lens cap. Optionally, a locking ring is coupled to the backplate and the transformer assembly further comprises a transformer locking ring removably coupled to the locking ring.

Additionally, the transformer assembly may further comprise: a housing having at least one exterior groove; a driver board assembly mounted in the housing; and an o-ring mounted in the at least one exterior groove; the housing being configured to mount in the circuit compartment. Optionally, the lamp may have a wire assembly coupled to the transformer assembly and a wire protector removeably coupled to the transformer assembly using at least one fastener. Optionally, a heat sink may be removably coupled to the body, the heat sink further comprising a first half removably coupled to a second half by a plurality of fasteners. Optionally, the lamp further comprises a plurality of lenses having different optical qualities removably coupleable to the body. The light emitting diode compartment may have a wall with a thickness of at least about 3 mm.

In an additional embodiment, the present invention is directed to a lamp comprising a body having a threaded outer surface; a light emitting diode compartment having a wall with a thickness of at least about 3 mm; and a circuit compartment having an inner wall with a groove, the circuit compartment being separated from the light emitting diode compartment by a backplate having a thickness of at least about 8 mm. The lamp further comprises a light emitting diode coupled to a base board, the base board being fastened to the backplate by a fastener to mount the light emitting diode in the light emitting diode compartment. The lamp further comprises a driver board assembly in the circuit compartment; a lens removeably mounted to the housing with a removable lens cap; and a heat sink removeably coupled to the body, the heat sink further comprising a first half removably coupled to a second half by a plurality of fasteners.

### THE DRAWINGS

A better understanding of the present invention will be had with reference to the accompanying drawings in which:

FIG. 1 is a an exploded perspective view of a lamp according to a first embodiment of the present invention;

FIG. 2 is a cross sectional perspective view of the lamp of FIG. 1;

FIG. 3 is an exploded perspective view of a lamp according to a second embodiment of the present invention;

FIG. 4 is a cross sectional perspective view of the lamp of FIG. 3;

FIG. 5 is a is an exploded perspective view of a lamp according to a third embodiment of the present invention;

FIG. 6 is a cross sectional perspective view of a lamp having a modular transformer according to a fourth embodiment of the present invention;

FIG. 7A is side elevation view of a lens usable with the lamps of FIGS. 1 to 6;

FIG. 7B is a cross sectional perspective view of the lens of FIG. 7A; and

FIG. 8 is an exploded perspective view of a heat sink usable with the lamps of FIGS. 1 to 6.

### DETAILED DESCRIPTION

In the following description of preferred embodiments, reference is made to the accompanying drawings that form a part hereof, and in which is by way of illustrations specific embodiments in which the invention may be practiced. It is to be understood that other embodiments may be utilized and structural changes may be made without departing from the scope of the preferred embodiments of the present invention.

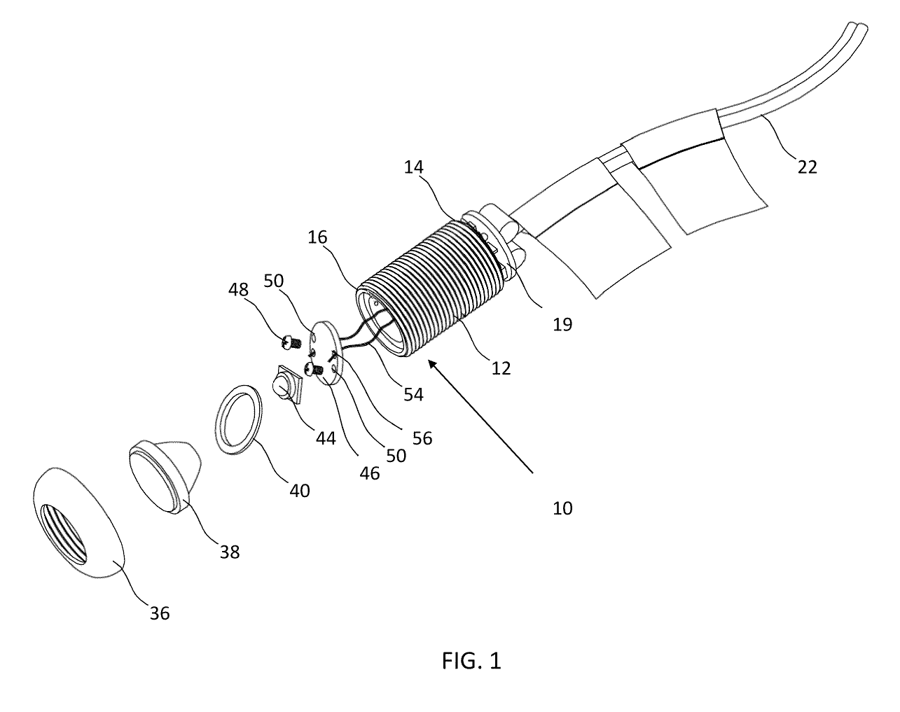

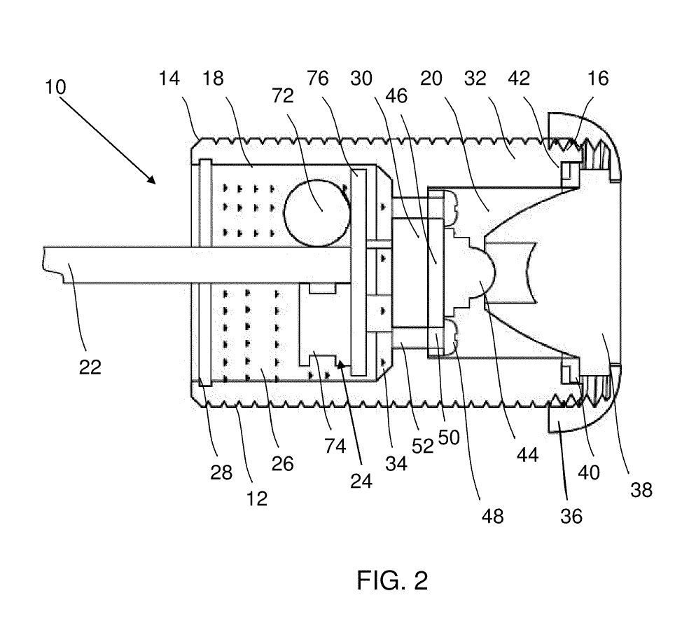

The present invention, according to an embodiment, is directed to an LED lamp having driver circuitry integrated into a body capable of fitting interchangeable lenses and/or interchangeable heat sinks. With reference to FIGS. 1 to 5, an LED lamp 10 according to an embodiment of the present invention has a body 12. The body 12 has a wire end 14 and a lens end 16. The body 12 may have an outer diameter of between about 20 mm and about 30 mm. In an embodiment, the body 12 has an outer diameter of about 26 mm. Preferably, the outside of the body is threaded for the attachment of interchangeable lenses and interchangeable heat sinks. In an embodiment the thread pitch is about 1.5 mm. Preferably, the body 12 is made of a material capable of conducting heat away from components inside the body. For example, the body 12 may be made of aluminum, brass or other materials.

The body 12 is divided into a circuit compartment 18 and an LED compartment 20. A wire assembly 22 connectable to a current source (not shown) is coupled to a driver board assembly 24. The driver board assembly 24 is positioned inside of the wire end 14 of the body 12 and in the circuit compartment 18. Preferably the driver board assembly 24 is attached to the body 12 using an adhesive 26, such as an epoxy or silicone compound. In a preferred embodiment, the adhesive 26 has a temperature tolerance over 105° C. and more preferably over 130° C. Typically, silicone adhesives maintain flexibility well during temperature fluctuations. In an embodiment, the adhesive constitutes a mixture of epoxy and silicone compound.

In a preferred embodiment, the circuit compartment 18 has a groove 28 within which the adhesive sits to hold the driver board 24 assembly. When the adhesive 26 is placed in the circuit compartment 18, the adhesive fills the groove 28. Once the adhesive hardens, the adhesive becomes strongly attached to the body 12 and prevents the wire assembly 22 and the driver board assembly 24 from being pulled apart from the body.

Preferably, the body 12 has a backplate 30 between the circuit compartment 18 and the LED compartment 20. In an embodiment, the thickness of the backplate 30 is between about 2 mm and about 15 mm. Preferably, the thickness of the backplate 30 is at least about 8 mm to prevent heat from being trapped directly underneath the LED and to allow for heat transfer through the body. The LED compartment 20 has a wall 32. Preferably the thickness of the wall 32 is greater than about 3 mm and more preferably greater than about 4 mm to allow for heat transfer through the body 12 and good strength and integrity of the body. In a preferred embodiment of the present invention, the circuit compartment 18 has an angled corner 34 where an internal wall meets the backplate 30. Preferably, the angle is between about 20 and about 70 degrees, and more preferably between about 40 and about 50 degrees. The angled corner 34 provides increased mass to better transfer heat.

A lens cap 36 is threadable onto the lens end 16 of the body 12 to hold a lens 38. The lens cap 36 may be made from metal, plastics such as acrylic or polycarbonate, or other suitable material. In a preferred embodiment, the lens cap 36 is made of aluminum is and is threaded and configured to fit flush with the lens 38 and the lens end 16 of the body 12. By having a flush mounted lens cap 36, the design is cleaner looking, less likely to snag on an object brushing against the lamp 10, less likely to retain dirt and dust, and is easier to make waterproof. The lens 38 may be made of plastic such as acrylic or polycarbonate. In a preferred embodiment, the lens 38 is made of Poly(methyl methacrylate)(PMMA).

Optionally, a sealing gasket 40 is fitted between the lens 38, the lens cap 36 and the body 12. In a preferred embodiment, the gasket 40 is made of silicone rubber and has a flat side to ensure that the gasket 40 sits on a rim 42 of the body 12 and a ridge for holding other components. The gasket 40 helps ensure a waterproof lamp 10. In an embodiment, the rim 42 preferably has a width greater than about 1 mm and more preferably greater than about 2 mm to securely seat the gasket 40, the lens 38 and the lens cap 36.

The lamp 10 also has at least one high output LED 44 mounted to a base board 46. The LED 44 may be soldered to the base board 46. The LED 44 may be made for example by Cree in Durham, N.C. or Edison Opto-electronics in Santa Fe Springs, Calif. The LED 44 and base board 46 are preferably fastened to the body 12 by at least one fastener 48 through a fastener hole 50 in the base board 46 and into a hole 52 in the backplate 30. In an embodiment, the base board 46 is fastened to the body using two screws.

Preferably, a thermal compound is placed between the base board 46 and the backplate 30. A plurality of wires 54 extend from the driver board assembly 24 through wire holes 56 to the LED 44 to provide power to the LED. By fastening the base board 46 to the body 12, even pressure of the base board 46 on the backplate 30 may be assured. The even pressure helps heat transfer and prevents premature LED failure. In an embodiment, the circuit compartment 18 has an insulator (not shown) to prevent arcing with the driver board assembly 24.

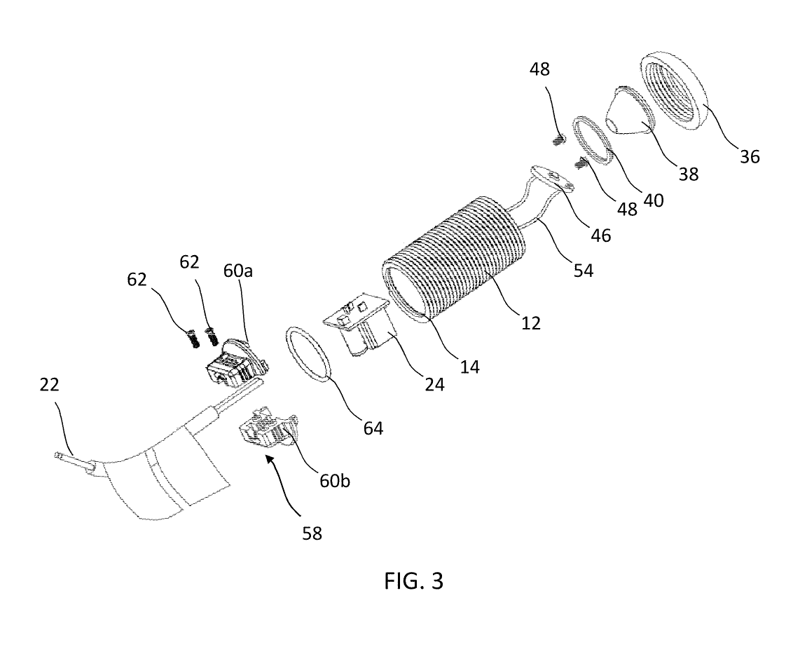

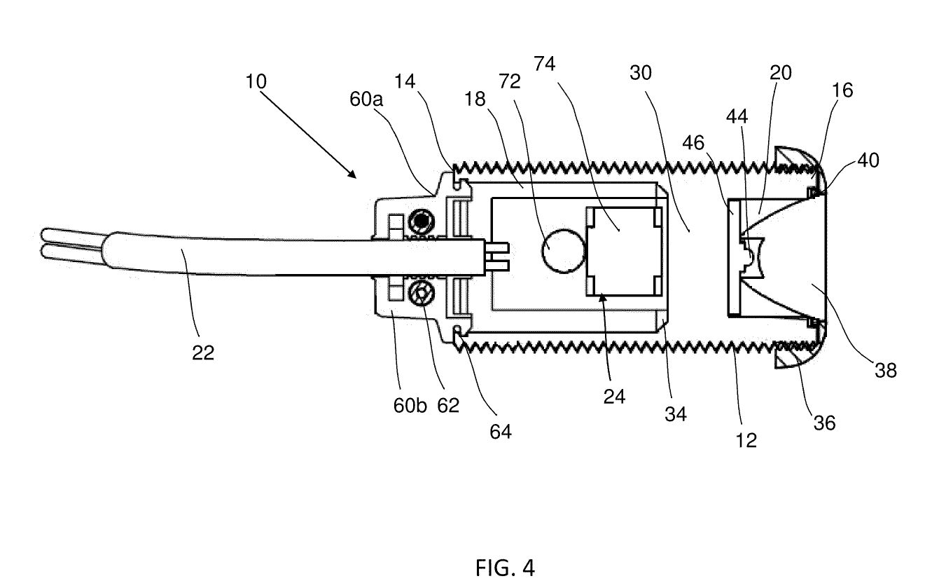

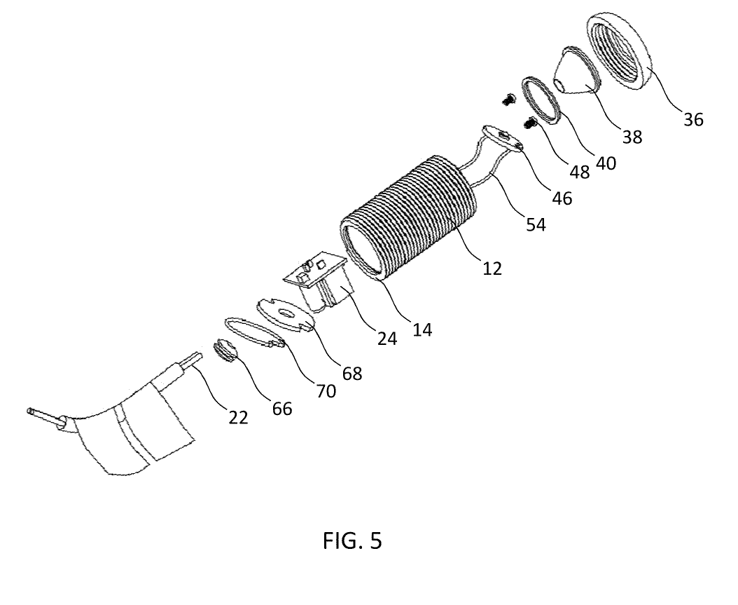

In a second embodiment of the present invention, as shown in FIGS. 3 and 4, a wire protector 58 is placed around the wire assembly 22 and inserted into the wire end 14 of the body 12. The wire protector 58 has two halves 60a, 60b that mate around the wire assembly 22 and are fastened to each other using at least one fastener 62. In an embodiment, two fasteners 62 couple the halves 60a, 60b together around the wire assembly 22. The wire protector 58 is configured to fit and lock within the wire end 14 of the body 12 to prevent stresses on the wire assembly 18 from breaking electrical connections within the body 12. Additionally, the wire protector 58 can be used as a handle when placing body 12 in a heat sink or other fixture. For example, a user can turn the body relative to a heat sink or fixture using the wire protector 58 to thread the body within the heat sink or fixture even when the heat sink or other fixture covers all of the exterior theads on the body 12. Optionally, a wire protector o-ring 64 fits in the wire end 14 of the body 12 with the wire protector 58 to create a water-resistant seal. In a third embodiment of the present invention, as shown in FIG. 5, the wire 18 passes through a wire clip 66. The wire clip 66 is configured to seat within a mounting disc 68, which in turn is placed in an o-ring 70 in the wire end 14 of the body 12.

Thus, there are several improvements in the lamp 10 that make the lamp more durable, allow the lamp to dissipate heat better and allow the lamp to obtain an Energy Star, UL or other industry certifications. The driver board assembly 24 contains circuitry to avoid the need for an external transformer. In an embodiment, the driver board assembly 24 has a capacitor 72, an inductor 74 and a printed circuit board 76. Different driver board assemblies may be used in the lamp to transform different voltages (e.g. 110, 220 or 277) and different currents (e.g. alternating current or direct current) into suitable voltages and currents for different LEDs. For example, in various embodiments, the LED is a 1 watt, 3 watt, 5 watt or 7 watt LED.

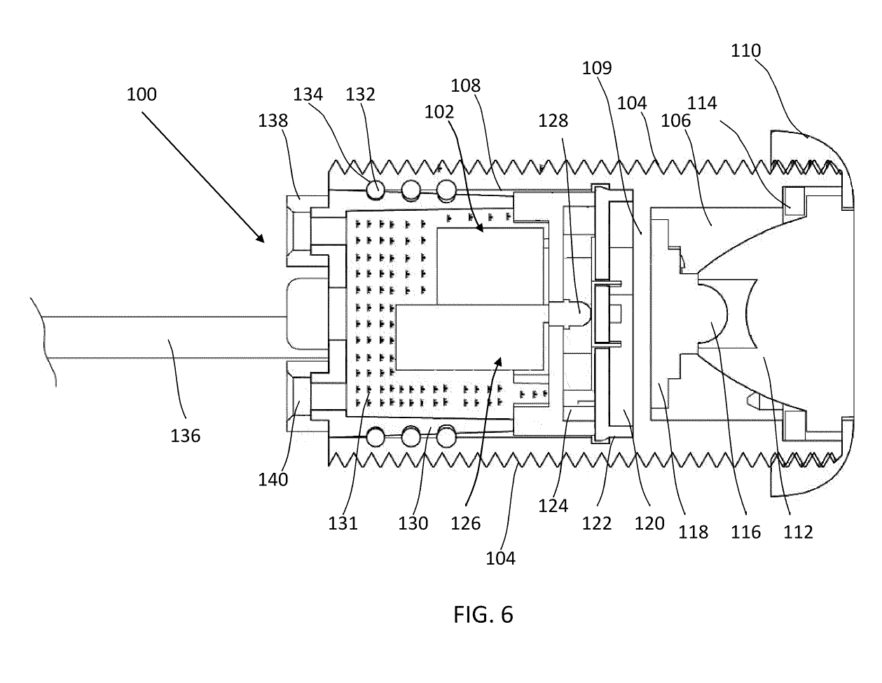

With reference to FIG. 6, the present invention, according to a fourth embodiment, is directed to a lamp 100 having a removeable transformer assembly 102. The lamp has a body 104 with an LED compartment 106 and a circuit compartment 108. A backplate 109 separates the

LED compartment 106 and the circuit compartment 108. An outside of the body 104 is threaded to allow for attachment of a lens cap 110 to hold a lens 112. Optionally a heat sink may be attached to the threaded body. Optionally, an inside of the LED compartment is threaded for attachment of a lens cap or threaded lens. As in previously described embodiments, a sealing gasket 114 fits between the lens 112, the lens cap 110 and the body 104. As in previously described embodiments, the lamp 100 has at least one high output LED 116 mounted to a base board 118 which is in turn mounted in the LED compartment 106 using an adhesive, such as epoxy, or fasteners.

A plurality of electrical contacts (not shown) extend through the back plate 109. A locking ring 120 is coupled to the back plate 109 such as by adhesive or fastener. The locking ring contains a metal contact plate 122. The transformer assembly 102 has a transformer locking ring 124 that removeably locks with locking ring 120, such as via rotation of the transformer locking ring 124 relative to the locking ring 120. Transformer assembly 102 has a driver board assembly 126 and a metal contact point 128. The driver board assembly 126 is mounted in a housing 130 by an adhesive, such as epoxy 131. The housing 130 is configured to fit snugly in the circuit compartment 108. In an embodiment, at least one o-ring 132 is mounted in a groove 134 inside the transformer compartment 108 to enable the transformer assembly 102 to be mounted inside of the transformer compartment in a waterproof manner.

A wire assembly 136 is coupled to the transformer assembly 102. In an additional embodiment, a wire protector 138 holds the wire assembly 136 to the transformer assembly 102. The wire protector 138 may be removably attached to the transformer assembly 102 using at least one fastener 140.

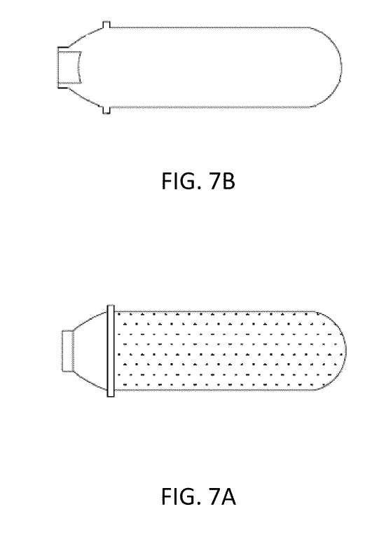

The lamps previously described are advantageous in that the threaded bodies and lens caps allow for the use of many different types of lenses with standardized bases. These lenses allow for diffused or narrowly focused beams from the LED. In addition to the lenses shown in FIGS. 1 to 5, numerous other lenses may be used. FIGS. 7a and 7b show an example of a lens allowing light to be diffused nearly 360 degrees from the LED. The lens shown in FIGS. 6a and 6b can be made longer or shorter as desired.

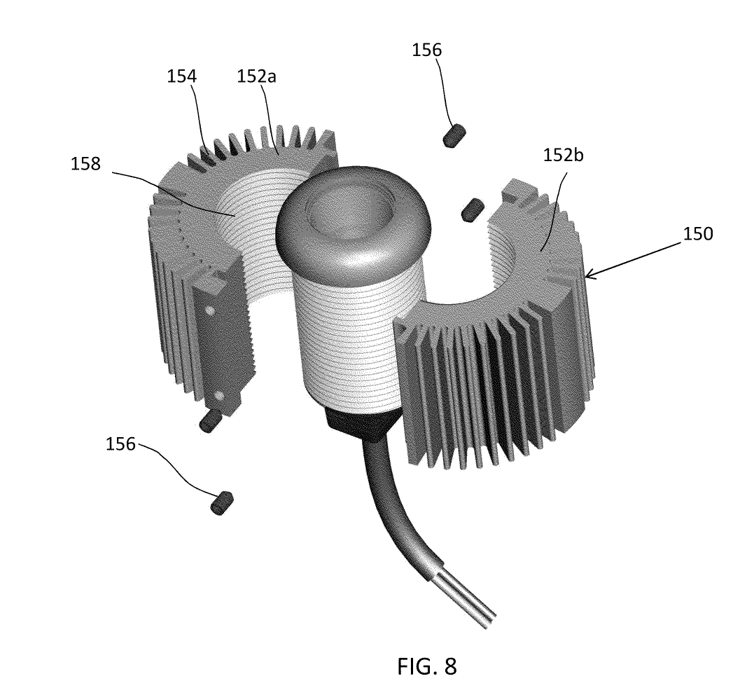

Additionally, the lamps previously described are advantageous in that the threaded bodies allow for the use of many different types of heat sinks and fixtures designed to fit on the body 12. A heat sink 150 according to an embodiment of the present invention is shown in FIG. 8. Preferably, the heat sink 150 is made of aluminum, but may be formed of other heat conducting materials, such as other metals. The heat sink 150 has two halves 152a, 152b that made to each other. The halves 152a, 152b may have the same shape or may be complementary to each other. The heat sink 150 has a plurality of fins 154 to increase the surface area of the heat sink to allow for better heat dissipation. In an embodiment, the halves are joined together with a plurality of fasteners 156 . In an embodiment, the fasteners 156 are made of a harder material than the halves 152a, 152b and can thread themselves into the halves. In an additional embodiment, the fasteners 156 are held in place by friction and can be snapped in without the use of additional tools. Each of the halves 152a, 152b has a threaded surface 158 for mating with the threads on the outside of the body 12. The heat sink shown in FIG. 7 is advantageous because a user does not have to thread the body 12 through the heat sink 150 but can quickly assemble the halves 152a, 152b around the body and affix the heat sink 150 to the body using the fasteners 156.

In sum, the present invention allows for lamps with a high degree of interchangeability and configurability. For a given configuration, lamps according to the present invention allow users change lens types and lens angles. The user may also change the bezel for different appearances and applications. The user may also use a plurality of different heat sinks. Additionally, the user may configure the unit with different types of wires and connectors, such as bi-pins (e.g. GX 5.3 or GU 5.3 bases), bayonetes, medium bases (E27, E17, E14 and E12) and other bases. The interchangeability and configurability allow for many different applications including, for example, outdoor landscape lights, indoor spot lights, pendants, and path lights.

Although the present invention has been described in considerable detail with reference to certain preferred versions thereof, other versions are possible. Therefore, the spirit and scope of the appended claims should not be limited to the description of the preferred versions described herein.

All features disclosed in the specification, including the claims, abstract and drawings, and all the steps in any method or process disclosed, can be combined in any combination except combinations where at least some of such features and/or steps are mutually exclusive. Each feature disclosed in the specification, including the claims, abstract, and drawings can be replaced by alternative features serving the same, equivalent or similar purpose, unless expressly stated otherwise. Thus, unless expressly stated otherwise, each feature disclosed is a one example only of a generic series of equivalent or similar features.

Any element in a claim that does not explicitly state “means” for performing a specified function or “step” for performing a specified function, should not be interpreted as a “means” or “step” clause as specified in 35 U.S.C. §112.

What is claimed is:

1. A lamp comprising:
a. a body having
a threaded outer surface;
a light emitting diode compartment; and
a circuit compartment;
b. a light emitting diode mounted in the light emitting diode compartment;
c. a driver board assembly mounted in the circuit compartment; and
d. a lens removably mounted to the housing with a removable lens cap.

2. The lamp of claim 1 wherein the transformer is removeably mounted in the transformer compartment.

3. The lamp of claim 1 wherein the light emitting diode compartment and the transformer compartment are separated by a backplate having a thickness of at least about 8 mm.

4. The lamp of claim 3 wherein the circuit compartment further comprises an inner wall having a groove; the driver board assembly being held inside of the circuit compartment with an adhesive filling the groove.

5. The lamp of claim 4 wherein the inner wall of the circuit compartment meets the backplate at an angled corner.

6. The lamp of claim 1 wherein the light emitting diode compartment further comprises a wall having a thickness of at least about 3 mm.

7. The lamp of claim 6 wherein the wall of the light emitting diode compartment further comprises a rim and wherein the lamp further comprises an o-ring that sits on the ledge and is held in place by at least one of the removable lens cap and the lens.

8. The lamp of claim 1 wherein the body further comprises a lens end and wherein the removable lens cap is configured to mount flush with the lens and the lens end of the body.

9. The lamp of claim 1 wherein the light emitting diode compartment and the transformer compartment are separated by a backplate having a thickness of at least about 8 mm; the light emitting diode is coupled to a base board and the base board is fastened to the backplate using a fastener.

10. The lamp of claim 9 further comprising a wire assembly coupled to the driver board assembly, the wire assembly fastened to the body by a wire protector.

11. The lamp of claim 1 further comprising a heat sink removably coupled to the body, the heat sink further comprising a first half removably coupled to a second half by a plurality of fasteners.

12. The lamp of claim 1 further comprising a plurality of lenses having different optical qualities removably coupleable to the body.

13. A lamp comprising:
a. a body having
a threaded outer surface;
a light emitting diode compartment and a circuit compartment separated by a backplate, the backplate having a thickness of at least about 8 mm;
b. a light emitting diode mounted in the light emitting diode compartment; and
c. a transformer assembly removeably mounted in the circuit compartment; and
d. a lens removeably mounted to the housing with a removable lens cap.

14. The lamp of claim 13 wherein a locking ring is coupled to the backplate and wherein the transformer assembly further comprises a transformer locking ring removably coupled to the locking ring.

15. The lamp of claim 14 wherein the transformer assembly further comprises:
a housing having at least one exterior groove;
a driver board assembly mounted in the housing; and
an o-ring mounted in the at least one exterior groove; and
wherein the housing is configured to mount in the circuit compartment.

16. The lamp of claim 15 further comprising a wire assembly coupled to the transformer assembly; and a wire protector removeably coupled to the transformer assembly using at least one fastener.

17. The lamp of claim 13 further comprising a heat sink removably coupled to the body, the heat sink further comprising a first half removably coupled to a second half by a plurality of fasteners.

18. The lamp of claim 13 further comprising a plurality of lenses having different optical qualities removably coupleable to the body.

19. The lamp of claim 13 wherein the light emitting diode compartment further comprises a wall having a thickness of at least about 3 mm

20. A lamp comprising:
a. a body having
a threaded outer surface;
a light emitting diode compartment having a wall with a thickness of at least about 3 mm; and
a circuit compartment having an inner wall with a groove, the circuit compartment being separated from the light emitting diode compartment by a backplate having a thickness of at least about 8 mm;
b. a light emitting diode coupled to a base board, the base board being fastened to the backplate by a fastener to mount the light emitting diode in the light emitting diode compartment; and
c. a driver board assembly in the circuit compartment;
d. a lens removeably mounted to the housing with a removable lens cap; and
e. a heat sink removeably coupled to the body, the heat sink further comprising a first half removably coupled to a second half by a plurality of fasteners.
